(19) United States
(12) Patent Application Publication
(10) Pub. No.: US 2021/0220922 A1
(43) Pub. Date: Jul. 22, 2021

(54) THREADED BIT ADAPTERS

(71) Applicant: Rocky Mountain Twist Corporation, Ronan, MT (US)

(72) Inventor: Nathan C. Cantlon, Charlo, MT (US)

(21) Appl. No.: 17/154,975

(22) Filed: Jan. 21, 2021

Related U.S. Application Data
(60) Provisional application No. 62/964,574, filed on Jan. 22, 2020.

(51) Int. Cl. B23B 31/00; B25F 3/00

(52) U.S. Cl. CPC B23B 31/005; B25H 3/003; B25F 3/00

(57) ABSTRACT

Adapters are configured to couple a driver with a threaded bit, such as a threaded aerospace bit. The adapter includes an elongate body having a threaded adapter portion and a shank portion formed in the body. The threaded adapter portion includes an annular shroud with a plurality of threads formed in an inward-facing surface of a wall thereof.

### CROSS REFERENCE TO RELATED APPLICATION

This application claims the benefit under 35 U.S.C. § 119 of U.S. Provisional Patent Application No. 62/964574, filed Jan. 22, 2020, which is hereby incorporated by reference in its entirety for all purposes.

### BRIEF DESCRIPTION OF THE SEVERAL VIEWS OF THE DRAWINGS

The foregoing aspects and many of the attendant advantages of the claimed subject matter will become more readily appreciated by reference to the following detailed description, when taken in conjunction with the accompanying drawings, wherein:

FIG. 1 shows an adapter formed in accordance with one non-limiting embodiment of the present disclosure, in addition to a driver, a threaded bit, and a bit set.

FIG. 2A shows a front upper perspective view of an adapter formed in accordance with one non-limiting embodiment of the present disclosure.

FIG. 2B shows a rear upper perspective view of the adapter of FIG. 2A.

FIG. 3A shows a side elevation section view of the adapter of FIG. 2A.

FIG. 3B shows a side elevation view of the adapter of FIG. 2A.

FIG. 4A shows a rear elevation view of the adapter of FIG. 2A.

FIG. 4B shows a front elevation view of the adapter of FIG. 2A.

FIG. 5A shows a partial side elevation section view an adapter formed in accordance with one non-limiting embodiment of the present disclosure, coupled with a driver and a threaded bit.

FIG. 5B shows a close up side elevation section view of the adapter of FIG. 5A.

### DETAILED DESCRIPTION

At this time, over 50% of the drilling and driving power tools sold are impact drivers. These drivers are commonly fitted with quick change hex drive chucks from the manufacturers. Additionally, these drivers offer a more compact design than previous driving tools, because space is always a consideration.

The aerospace industry uses specialty drill bits for the assembly of aircraft. These tools are fitted with a specific threaded shank adaption having a permanently attached ¼-28 threaded shank. These shanks aid in attachments that take up less space.

The present disclosure provides adapters that enable threaded aerospace bits (and other threaded bits and tools) to be adapted to the existing power tools having hex drive chucks and traditional jawed chucks (e.g., three jawed chucks). The inventive adapters bring the precision and space savings from the aerospace manufacturing world into the reach of the average consumer.

As explained below, the adapters allow for extremely compact drills that will fit in previously unreachable spaces. Additionally, the adapters prevent the bits from slipping in the chuck. Further, the adapters provide a physical depth limit during the drilling operation, which has safety benefits such as not extending beyond a drilled surface and preventing the inadvertent drilling of a subsequent surface that may be behind the drilled surface. These advantages are representative, not limiting.

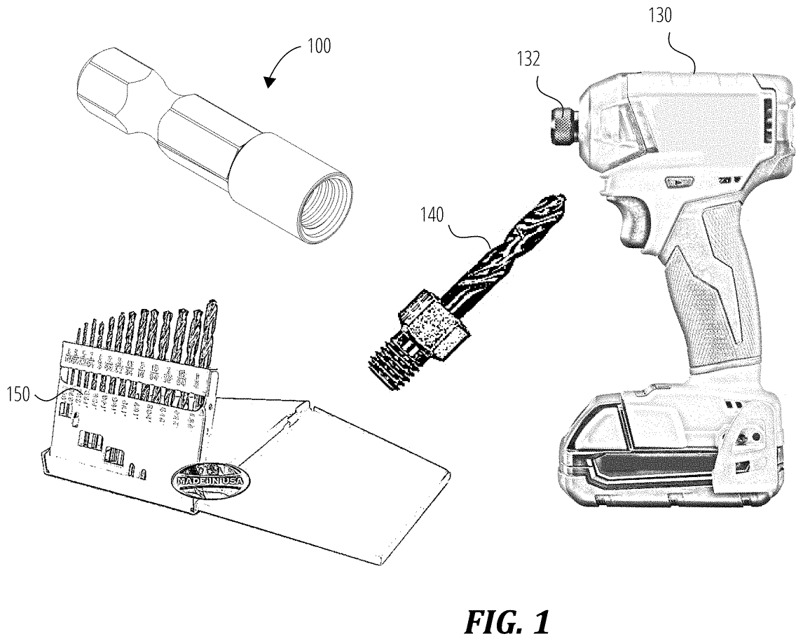

FIG. 1 shows a representative adapter 100 formed in accordance with a non-limiting embodiment of the present disclosure, as will be described in greater detail below. Generally, the adapter 100 is configured for use with a driver 130 having a chuck 132 (e.g., a hex drive chuck or a three-jawed chuck). For example, the adapter 100 is configured to couple a threaded tool or bit 140 to the driver 130. In some embodiments, the adapter 100 is part of a kit, e.g., a kit including one or more of the driver 130 or at least one threaded bit 140 (such as a bit set 150).

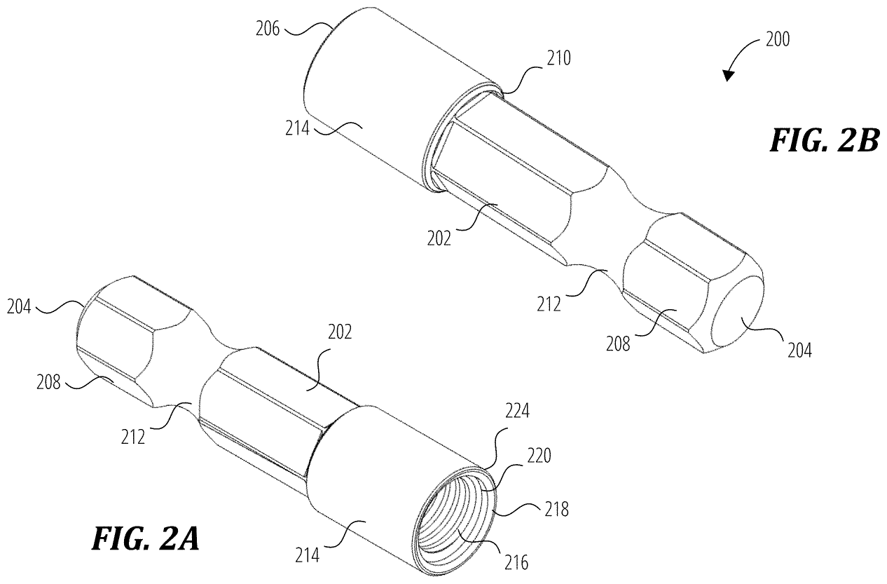

FIG. 2A-2B show perspective views of a representative adapter 200 formed in accordance with one non-limiting embodiment of the present disclosure. The adapter 200 is generally formed from a single piece of metal, such as a steel alloy (e.g., a chrome vanadium steel alloy), or other suitably hard and durable material. In some embodiments, the adapter 200 is formed of a single piece of metal from one or more forging, casting, treatment, and/or machining steps.

The adapter 200 has an elongate body 202 delimited by a driver end 204 and a bit end 206. The driver end 204 is the end generally configured for secure coupling with a chuck of a driver (e.g., the chuck 132 of the driver 130 of FIG. 1). As described below, the bit end 206 is configured to threadedly couple with a threaded tool bit (such as the threaded bit 140 of FIG. 1). As used herein, the body 202 generally refers to the entire length of the adapter 200. The body 202 has an overall length between the driver end 204 and the bit end 206 of between about 1 inch to about 30 inches, and an outer diameter of about 0.25 inches to about 2 inches.

A shank portion 208 is formed in the body 202 beginning at or near the driver end 204 and extending along the body 202 up to a transition region 210, where a threaded adapter portion 214 begins. In the illustrated embodiment, the shank portion 208 has a hexagonal cross sectional shape along a substantial portion of its length, with the exception of a ball groove 212 formed around the body 202 at an intermediate location along the shank portion 208. Together, the shank portion 208 and the ball groove 212 configure the body 202 to be received by a chuck of a driver, in particular a hex drive chuck (e.g., a quick-release hex drive chuck).

In some embodiments, the shank portion 208 does not have a hexagonal cross section or a ball groove 212. In such embodiments, the shank portion 208 forms a straight shank (e.g., with a circular cross section) such as is configured to be secured by a jawed chuck (e.g., a three jawed chuck).

The threaded adapter portion 214 is the portion of the body 202 configured to receive a threaded bit. As shown in FIGS. 2A and 2B, the threaded adapter portion 214 is formed as an annular blind shroud 224 having a plurality of threads 216 formed in a radially-inward facing surface 220 of a wall thereof. An optional seat 218 is formed at the bit end 206 of the shroud 224. These features are described in greater detail below.

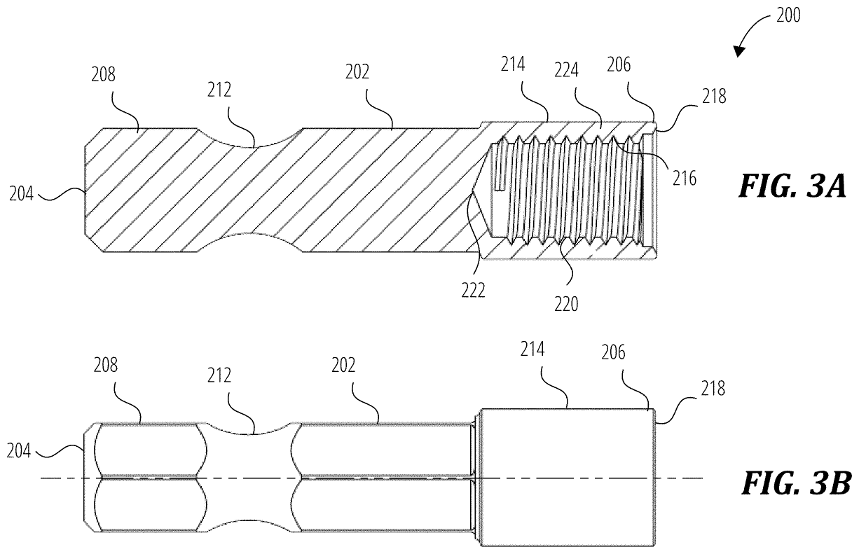

FIG. 3A and FIG. 3B show side elevation views of the adapter 200 of FIG. 2A-2B. In particular, FIG. 3A shows a side elevation section view that facilitates understanding of the threaded adapter portion 214.

As shown, the threaded adapter portion 214 has a plurality of threads 216 formed in a radially-inward facing surface 220 of a wall of the shroud 224. In some embodiments, the threads 216 conform to National Aerospace Standard 965. In some embodiments, the threads 216 are ¼-28 threads. In some embodiments, the threads 216 are another Uniform Thread Standard thread. The foregoing thread specifications are representative, not limiting.

The threaded adapter portion 214 has a blind bottom 222 with a recessed surface in this embodiment, to facilitate fastening and removal of the threaded bit. In some embodiments, the blind bottom 222 has a flat surface.

The optional seat 218 of the threaded adapter portion 214 is configured to facilitate correct insertion of a bit. Accordingly, the seat 218 has a conical or chamfered profile that centers the bit as it is inserted into the threaded adapter portion 214. In some embodiments, the seat 218 has a slightly larger outer diameter than the threads 216.

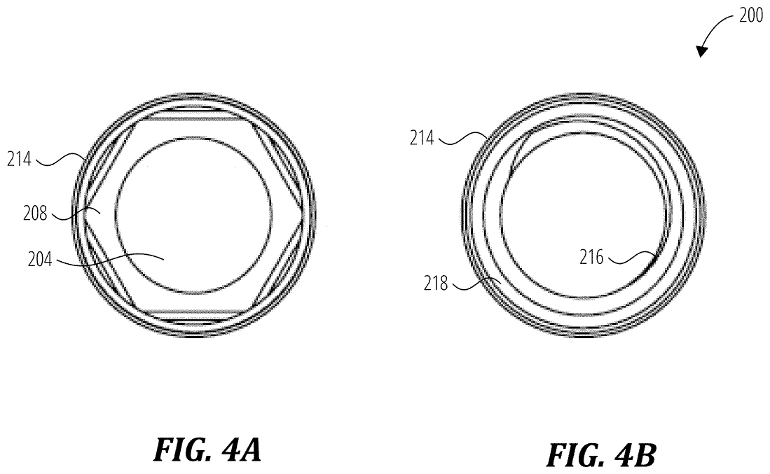

FIG. 4A-4B show end views of the driver end 204 and the bit end 206 of the adapter 200, respectively. As shown, the threaded adapter portion 214 is centered with the shank portion 208. The threaded adapter portion 214 has a larger cross sectional dimension than the shank portion 208 in the illustrated embodiment. However, in some embodiments, the shank portion 208 has a larger cross sectional dimension than the threaded adapter portion 214. The outer diameter of the threaded adapter portion 214 generally depends on the size of threaded bit it is configured to receive; accordingly, in some embodiments, the threaded adapter portion 214 has a larger or smaller diameter. As shown in FIG. 4B, the seat 218 has a slightly larger outer diameter than the threads 216, in order to center the bit as it is inserted into the threaded adapter portion 214.

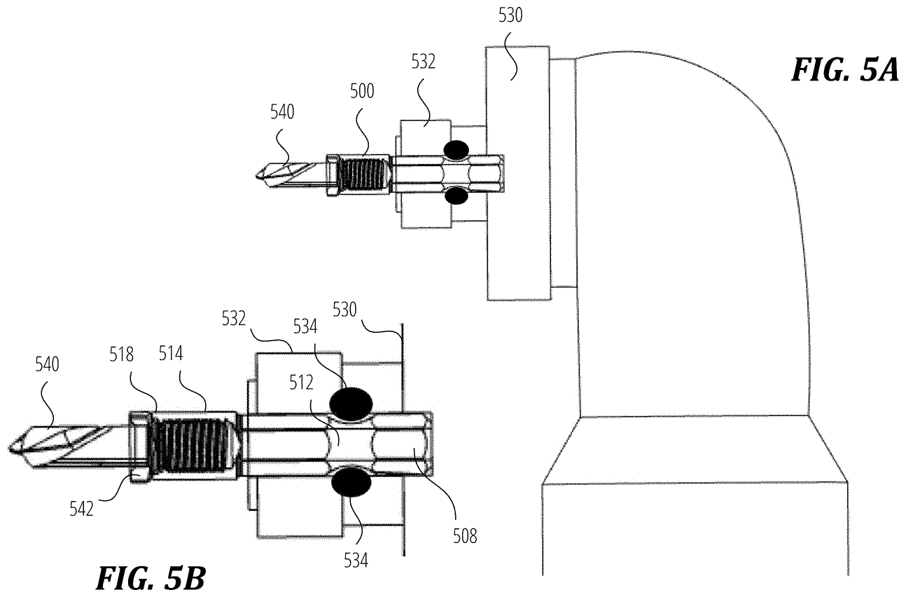

FIG. 5A-5B show another adapter 500 in accordance with one non-limiting embodiment of the present disclosure. The adapter 500 has the features of the adapter 200 of FIG. 2A-4B, and accordingly alike part names have alike meanings. The adapter 500 is securely coupled to a driver 530 (e.g., an impact driver or a drill), and in particular to a chuck 532 of the driver 530 (in this embodiment, a hex drive chuck).

Referring to FIG. 5B, the shank portion 508 of the adapter 500 is secured with the chuck 532. In this embodiment, balls 534 of the chuck 532 engage a ball groove 512 of the adapter 500, such that it may not be removed from the chuck 532. A threaded bit 540 is inserted and threaded into a threaded adapter portion 514 of the adapter 500, thus coupling the bit 540 to the adapter 500, and thus to the driver 530. In this embodiment, a flange 542 of the bit 540 abuts a seat 518 of the threaded adapter portion 514; thus, the flange 542 forms a depth stop that prevents over-depth drilling. As another advantage, the seat 518 prevents the bit 540 from being over-tightened in the threaded adapter portion 514. In some embodiments, the bit 540 does not have a flange 542; in such embodiments, the seat 518 itself forms a depth stop that prevents over-depth drilling.

The present disclosure also provides product lines comprising the foregoing threaded bit adapters. As one representative example, a product line includes two or more of: a first product comprising a plurality of threaded drill bits and any of the threaded bit adapters of the present disclosure; a second product comprising a plurality of non-threaded bits and the threaded bit adapter of the present disclosure; and a third product comprising a driver and the threaded bit adapter of the present disclosure.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

The present application may also reference quantities and numbers. Unless specifically stated, such quantities and numbers are not to be considered restrictive, but representative of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. An adapter configured to couple a driver with a threaded bit, the adapter comprising: an elongate body having a threaded adapter portion and a shank portion formed in the body, wherein the threaded adapter portion includes an annular shroud with a plurality of threads formed on an inward-facing surface of a wall thereof.

2. The adapter of claim 1, wherein at least part of the shank portion is formed as a hexagonal shank.

3. The adapter of claim 2, wherein the shank portion includes a ball groove formed around the body.

4. The adapter of claim 1, wherein at least part of the shank portion is formed as a straight shank with a circular cross section.

5. The adapter of claim 1, wherein the threaded adapter portion includes a conical or chamfered seat formed at a bit end thereof.

6. The adapter of claim 1, wherein the plurality of threads are ¼-28 threads.

7. The adapter of claim 1, wherein the body is formed from a single piece of chrome vanadium steel.

8. A kit comprising the adapter of claim 1 and the threaded bit.

9. The kit of claim 8, further comprising a driver.

10. A product line, comprising:
a first product comprising a plurality of threaded drill bits and a first bit adapter configured to couple a driver with a threaded bit, the first bit adapter comprising an elongate body having a threaded adapter portion and a shank portion formed in the body, wherein the threaded adapter portion includes an annular shroud with a plurality of threads formed on an inward-facing surface of a wall thereof; and
a second product comprising a plurality of non-threaded bits and a second threaded bit adapter, wherein the second bit adapter is the same as the first bit adapter.

11. The product line of claim 10, further comprising a third product comprising the driver and a third bit adapter, wherein the third bit adapter is the same as the first bit adapter.
